(19) United States
(12) Patent Application Publication
(10) Pub. No.: US 2007/0035965 A1
(43) Pub. Date: Feb. 15, 2007

(54) Light diffuser tube for an LED array

(76) Inventor: Barrie James Holst, Baulkham Hills (AU)

Correspondence Address: ABELMAN, FRAYNE & SCHWAB, 666 THIRD AVENUE, 10TH FLOOR, NEW YORK, NY, 10017, US

(21) Appl. No.: 11/359,817

(22) Filed: Feb. 21, 2006

(30) Foreign Application Priority Data
Aug. 9, 2005 (AU) 2005904282

(51) Int. Cl. F21V 7/04

(52) U.S. Cl. 362/608

(57) ABSTRACT

A light diffuser tube (10) for an LED array suitable for use with electronic gaming machines includes a mounting portion (11), a diffusion portion (12) and a body portion (13). The body portion (13) consists of side walls (14 and 15) connected by a base (16) to define therebetween an elongated passageway for receiving communication cables and associated electrics.

This invention relates to a light diffuser tube for use with a light emitting diode (LED) array suitable for use with, for example, electronic gaming machines.

High intensity light emitting diodes may be arranged in any configuration and are usually powered by light chaser circuits. However, a light emitting diode usually presents, in optical terms, as a high intensity light dot.

It is an object of the present invention to provide a light diffuser for an LED array to be seen as a light column of finite length (eg, 100 mm to 300 mm) evenly distributed about a wide diameter elongated optical tube of, say, 10 mm to 25 mm.

According to the invention there is provided a light diffuser tube for an LED array comprising a mounting portion, a diffuser portion and a body portion between the mounting portion and the diffuser portion.

In a preferred form of the invention, the body portion comprises a pair of spaced apart side walls, a base connecting the side walls and a throat opposite the base for receiving a printed circuit board upon which the LED array is arranged with the electrical cables and associated circuitry being located within the body portion and the LED array being located in the diffuser portion.

In order that the invention may be more readily understood and put into practical effect, the invention will now be described in relation to the accompanying drawings in which:

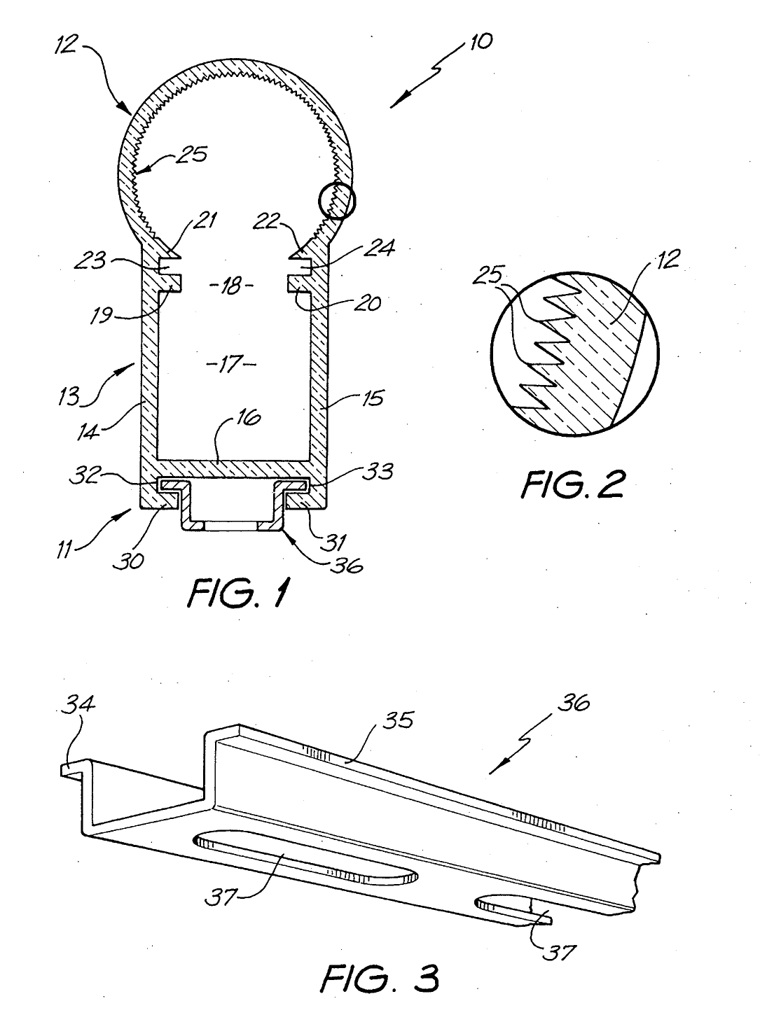

FIG. 1 is a cross sectional view of a light diffuser tube for an LED array according to one embodiment of the invention,

FIG. 2 is an enlarged view of the portion marked A of the diffuser tube shown in FIG. 1, and

FIG. 3 is a perspective view of a miniature top hat DIN rail for mounting the light diffuser tube within an electronic gaming machine.

The light diffuser tube 10 shown in FIG. 1 includes a mounting portion 11, a diffuser portion 12 and a body portion 13 between the mounting portion 11 and the diffuser portion 12. The body portion 13 consists of side walls 14 and 15 connected by a base 16 to define therebetween an elongated passageway for receiving communication cables and associated electrics. Opposite the base 16 there is a throat 18 defined by the inwardly directed flanges 19 and 20.

The diffuser portion 12 is integral with the body portion 13 and at its base has inwardly directed flanges 21 and 22 which with the flanges 19 and 20 define elongated slots 23 and 24 adapted to receive the side edges of a printed circuit board (not shown). The printed circuit board carries an array of LED's on its upper surface which project into the interior of the diffuser portion 12. The inside surface of the diffuser portion 12 is formed by lenticular elements 25 as shown in FIG. 2.

The mounting portion 11 is defined by inwardly directed flanges 30 and 31 which are spaced from the underside of the base 16 to define a pair of elongated slots 32 and 33 which receive the outwardly directed flanges 34 and 35 of the miniature top hat DIN rail 36. The rail 36 has openings 37 along its length for receiving fasteners adapted to secure the rail 36 to an electronic gaming machine.

The diffuser tube 12 may be of any shape, any size and any length, in straight sections or rounds or ovals and joined together as required. The diffuser tube can be attached around the edges of any existing light sign or illuminated light to increase the visual impact in order to draw attention to a particular sign.

The function of the diffuser tube is to distribute the light evenly over the outer surface of the diffuser portion so that it is seen from all viewing angles. This is predominantly different from an LED light which has a high visual impact on its axis with restricted viewing impact of low visual intensity off its axis.

The column of light can be used with the light chaser to drive different coloured LED's to alter the colours and sequencing of the light display around the outer perimeter of a sign to which the tube is affixed.

The light chaser and associated light tubes can be further operated to include communication sequencing so that all adjacent sides can be included in the same sequence driving patterns and in so doing present a complete effective lighting display with a common theme to highlight some special format or combined player programme.

The light diffuser tube may be manufactured from clear polycarbonate UL94, V-O, ultra violet stabilise with added translucent white colour of about 8%. The lenticular elements 25 on the inside of the diffuser portion 12 may be 0.5 mm to 0.6 mm in depth.

Various modifications may be made in details of design and construction without departing from the scope and ambit of the invention.

1. A light diffuser tube for an led array comprising a mounting portion, a: diffuser portion and a body portion between the mounting portion and the diffuser portion.

2. A light diffuser tube according to claim 1 wherein the body portion comprises a pair of spaced apart wide walls, a base connecting the side walls and a throat opposite the base for receiving a printed circuit board upon which the LED array is arranged with the electrical cables and associated circuitry being located within the body portion and the LED array being located in the diffuser portion.

3. A light diffuser tube according to claim 2 wherein the throat is defined by flanges directed inwardly from the side walls.

4. A light diffuser tube according to claim 3 wherein the diffuser portion has a base having inwardly directed flanges which with the flanges of the body portion define elongated slots adapted to receive the side edges of a printed circuit board.

5. A light diffuser tube according to claim 1 wherein the inside surface of the diffuser portion is formed by lenticular elements.

6. A light diffuser tube according to claim 1 wherein the mounting portion has inwardly directed flanges which are spaced from the underside of the base of the mounting portion to define a pair of elongated slots which are adapted to receive outwardly directed flanges of a miniature top hat DIN rail.
